(19) United States
(12) Patent Application Publication
(10) Pub. No.: US 2021/0364285 A1
(43) Pub. Date: Nov. 25, 2021

(54) ROTATING LASER APPARATUS AND LASER RANGING METHOD

(71) Applicant: NORTHWEST INSTRUMENT INC., Dover, NJ (US)

(72) Inventors: Xin SHI, Shanghai (CN); David XING, Dover, NJ (US)

(21) Appl. No.: 17/391,597

(22) Filed: Aug. 2, 2021

Related U.S. Application Data
(63) Continuation of application No. PCT/CN2020/073734, filed on Jan. 22, 2020.

(30) Foreign Application Priority Data
Feb. 3, 2019 (CN) 201910108750.3

(51) Int. Cl. G01C 3/10; G01C 3/02

(52) U.S. Cl. CPC G01C 3/10; G01C 3/02

(57) ABSTRACT

A rotating laser apparatus includes a laser emitting module configured to emit a first laser and a second laser, the first laser and the second laser forming a first included angle; a rotating module configured to make the first laser and the second laser respectively rotate around a first rotation axis to form a first laser surface and a second laser surface that do not overlap with each other; and a base connected to the laser emitting module and the rotating module and configured to support the laser emitting module and the rotating module.

### CROSS-REFERENCES TO RELATED APPLICATIONS

This application is a continuation application of PCT Patent Application No. PCT/CN2020/073734, filed on Jan. 22, 2020, which claims priority to Chinese Patent Application No. 201910108750.3, filed on Feb. 3, 2019, the entire contents of both of which are incorporated herein by reference.

### FIELD OF THE DISCLOSURE

The present disclosure relates to the field of surveying and mapping, and in particular to a rotating laser apparatus and a laser ranging method based on the rotating laser apparatus.

### BACKGROUND

A leveling instrument is an instrument that provides a plane or a straight line reference. The leveling instrument can cooperate with the laser detector to control the level of any measuring point within a certain radius.

Common leveling instruments only have the function of providing a horizontal reference, and do not have the function of distance measurement. Generally, for the distance measurement, distance data is obtained by a special rangefinder, therefore, a receiver is attempted to be disposed on the leveling instrument to receive the emitted laser to determine the distance, but this way needs a complex structure and high cost to achieve, and because of the rotation, the sampling time of the ranging module is very short, resulting in low measurement accuracy.

A distance measurement solution is provided in Chinese patent application CN 10829 1809 A, where the leveling instrument can only emit one laser beam at a time. A first laser (this laser can be oriented horizontally or not) is emitted first and detected by a laser detector, and a tilting mechanism (such as the leveling device 54 or the tilting device 61 inside the leveling instrument or the height adjusting device 16 located on the tripod) is used to tilt an emitted laser to form a second laser to be received by the laser detector, and a tilt angle is obtained through the angle sensor, finally, the distance between the leveling instrument and the laser detector is calculated based on the difference between the two heights of the first and second laser beams on the laser detector received and obtained by the laser detector. The disadvantage of this implementation is that the formation of the two subsequent laser beams requires adjustment of the tilt angle each time, thereby increasing the operating frequency of the tilt mechanism and the operating frequency of the angle sensor, and the measurement of each point requires repeated operations, which causes the cumbersome process and errors easily.

Therefore, how to simplify the structure and improve the measurement accuracy is a technical problem to be solved urgently by those skilled in the art.

### SUMMARY

In view of the above technical problem, how to ensure the existing functions of the leveling instrument and make it have the ranging function, and finally achieve the maximum simplification of the structure and operation steps, thereby saving costs, simplifying the measurement operation, and bringing users convenient and user-friendly experience. The disclosed apparatus and method are directed to solve one or more problems set forth above and other problems.

One aspect of the present disclosure provides a rotating laser apparatus. The apparatus includes a laser emitting module configured to emit a first laser and a second laser; a rotating module configured to make the first laser and the second laser respectively rotate around a first rotation axis to form a first laser surface and a second laser surface that do not overlap with each other; and a base connected to the laser emitting module and the rotating module and configured to support the laser emitting module and the rotating module. The first laser and the second laser form a first included angle.

Another aspect of the present disclosure provides a laser ranging method. The laser ranging method includes: generating, by a laser emitting module, a first laser and a second laser, the first laser and the second laser forming a first included angle; rotating the first laser and the second laser around a first rotation axis respectively to form a first laser surface and a second laser surface that do not overlap with each other; receiving, by a laser detector that is a first distance away from the laser emitting module, the first laser and the second laser and determining position difference data based on positions irradiated on the laser detector by the first laser and the second laser; and determining a first distance between the laser emitting module and the laser detector based on the position difference data and the first included angle.

### BRIEF DESCRIPTION OF THE DRAWINGS

The embodiments are shown and clarified with reference to the drawings. These drawings serve to clarify the basic principle, so that only aspects necessary for understanding the basic principle are shown. The drawings are not to scale. In the drawings, the same reference numerals indicate similar features.

FIG. 1 shows a view of a rotating laser apparatus 100 according to an example embodiment of the present disclosure;

FIG. 2 shows a view of a laser emitting module 210 of the rotating laser apparatus 100 according to an example embodiment of the present disclosure;

FIG. 3 shows a view of another laser emitting module 310 of the rotating laser apparatus 100 according to an example embodiment of the present disclosure; and

FIG. 4 shows a flowchart of a laser ranging method 400 for distance measurement according to an example embodiment of the present disclosure.

Other features, characteristics, advantages and benefits of the present disclosure will become more apparent through the following detailed description in conjunction with the accompanying drawings.

### DETAILED DESCRIPTION

In the following detailed description of the preferred embodiments, reference will be made to the accompanying drawings constituting a part of the present disclosure. The drawings show specific embodiments capable of implementing the present disclosure by way of example. The exemplary embodiments are not intended to be exhaustive of all embodiments according to the present disclosure. It can be understood that other embodiments can be utilized, and structural or logical modifications can also be made without departing from the scope of the present disclosure. Therefore, the following detailed description is not restrictive, and the scope of the present disclosure is defined by the appended claims.

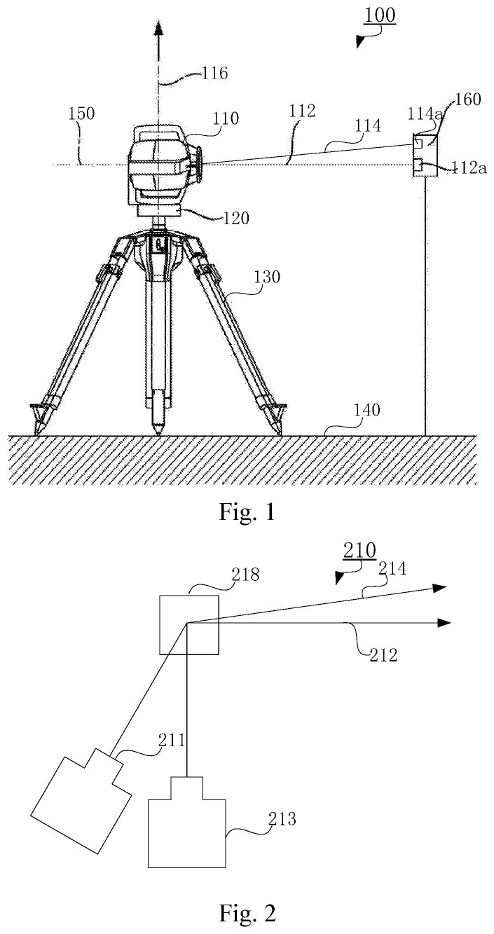

FIG. 1 shows a view of a rotating laser apparatus 100 according to the present disclosure, it can be seen from the drawing that the rotating laser apparatus 100 can include a laser emitting module 110 configured to emit first laser 112 and the second laser 114, wherein the first laser 112 and the second laser 114 form a first included angle (not marked with angle symbols in the drawing); in addition, the rotating laser apparatus 100 can also include a rotating module 120 configured to make the first laser 112 and the second laser 114 rotate around the first rotation axis 116 respectively to form a first laser surface and a second laser surface which do not overlap with each other. For example, the rotating module 120 includes one or more optical devices located on a light path of the first laser 112 and the second laser 114 emitted by the laser emitting module 110 and configured to rotate the first laser 112 and the second laser 114. The one or more optical devices of the rotating module 120 may also have reflection, refraction, and/or splitting functions. In some embodiments, the rotating laser apparatus 100 can further include a base 130 connected to the laser emitting module 110 and the rotating module 120 and configured to support the laser emitting module 110 and the rotating module 120. It can be seen from the drawing that the base 130 can be disposed on the working surface 140, so that the plane 150 formed by a laser beam emitted by the rotating laser apparatus 100 (such as the first laser 112) is parallel to the working surface 140. Optionally, the rotating laser apparatus 100 can further include a laser detector 160, so that the laser detector 160 can receive the first laser 112 and the second laser 114, and sense them at the areas 112a and 114a of its surface respectively.

The figure is merely exemplary and not restrictive, it seems to see from the figure that the first laser 112 and the second laser 114 will be irradiated on the laser detector 160 simultaneously, but it is only one of the implementation forms, and the others are of course also feasible, and other implementation forms will be described in the following embodiments.

In addition, although it can be seen from FIG. 1 that the rotating module 120 is located outside the laser emitting module 110, it does not mean that the laser emitting module 110 must be rotated as a whole, so that the first laser 112 and the second laser 114 respectively rotate around the first rotating shaft 116 to form a first laser surface and a second laser surface that do not overlap. Those skilled in the art should understand that, for example, the rotating module 120 can only rotate the laser emitted by the laser emitter without rotating the laser emitter itself to form the first laser surface and the second laser surface that do not overlap.

The rotating laser apparatus has the ability to emit first laser and second laser at a first included angle thereby an additional tilting mechanism such as a leveling device is not required; meanwhile, due to the first included angle between the first laser and the second laser is pre-configured, so that there is no angular error to make the measured distance more accurate.

FIG. 2 shows a view of an embodiment 210 of the laser emitting module of the rotating laser apparatus 100 according to the present disclosure, in this embodiment, the laser emitting module 210 includes a first laser emitter 211 and a second laser emitter 213, wherein the first laser emitter 211 is configured to generate the first laser 212 and the second laser emitter 213 is configured to generate the second laser 214. In this way, two independent laser emitters 211 and 213 can be employed to generate the first laser 212 and the second laser 214 so as to control the emission angles and wavelength ranges of the first laser 212 and the second laser 214 respectively, so that the first laser and the second laser can be configured separately for different application scenarios. In some embodiments, the first laser 212 and the second laser 214 have different wavelengths. In this way, an object such as a laser detector that receives the first laser 212 and the second laser 214 can distinguish the first laser 212 from the second laser 214 by wavelength, so as to provide assistance for the subsequent laser measurement. In some embodiments, the first laser 212 is visible light and the second laser 214 is invisible light, of course, the first laser 212 may be set as invisible light and the second laser 214 may be set as visible light. In this way, an object such as a laser detector that receives the first laser and the second laser can distinguish the first laser from the second laser by determining whether the laser is visible, so as to provide assistance for the subsequent laser measurement. Optionally, the laser emitting module 210 can include a laser direction adjustment module 218, which can adjust the emission angles of the first laser 212 and the second laser 214 as required.

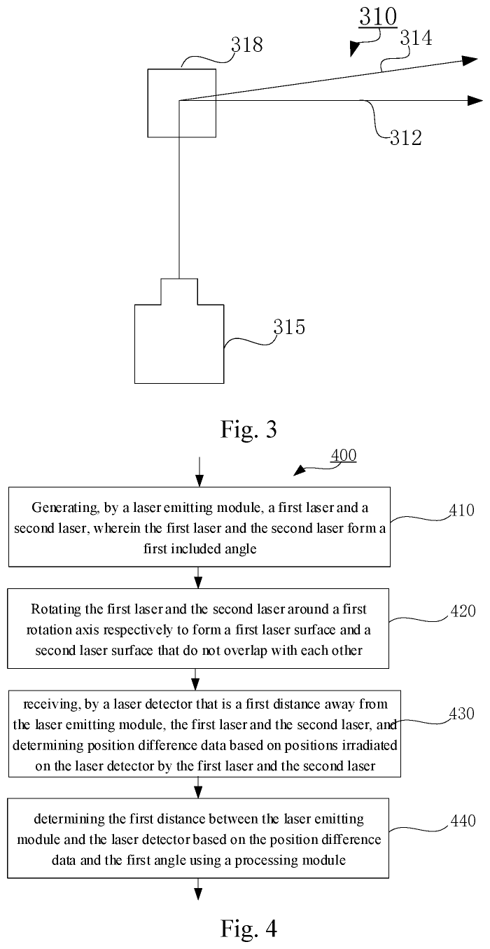

FIG. 3 shows a view of another embodiment 310 of the laser emitting module of the rotating laser apparatus 100 according to the present disclosure, in this embodiment, the laser emitting module only includes a laser emitter 215, at this time, the first laser 312 and the second laser 314 with different directions are generated by the optical device 318 for adjusting the direction of the laser generated by the laser emitter 315 included in the laser emitting module, wherein the optical device 318 is configured to adjust the laser generated by the laser emitter to produce the first laser 312 and the second laser 314. For example, the optical device 318 may include a spectroscope. In this way, it is possible to generate two laser beams 312 and 314 for laser ranging by only one laser emitter 315, thereby further simplifying the structure of the rotating laser apparatus 100 and reducing its manufacturing cost.

In some embodiments, the laser generated by the rotating laser apparatus 100 including the laser emitting modules 210 and 310 shown in FIGS. 2 and 3 may meet the following requirements, that is, in an embodiment according to the present disclosure, the second angle is formed between the projections performed by the first lasers 212, 312 and the second laser 214, 314 on a plane perpendicular to the first rotation axis 116. Therefore, it is possible to form the above-mentioned first and second angles to determine the angle between the first laser surface and the second laser surface that do not overlap, so as to provide assistance for the subsequent determination of the distance between the laser detector and the rotating laser apparatus. In an embodiment according to the present disclosure, the vertical projections of the first laser 212, 312 and the second laser 214, 314 on a plane perpendicular to the first rotation axis 116 are on the same straight line. In this way, the first laser and the plane which makes the first laser perpendicular to the first rotation axis are either in the same direction or differ by 180 degrees, so as to determine the distance between the laser detector and the rotating laser apparatus more accurately. In an embodiment according to the present disclosure, only one of the first laser surface and the second laser surface is perpendicular to the first rotation axis 116. In this way, it can be ensured that one of the first lasers 112, 212, 312 and the second lasers 114, 214, 314 is perpendicular to the first rotation axis 116, and another one of the first lasers 112, 212, 312 and the second lasers 114, 214, 314 are not perpendicular to the first rotation axis 116, that is, there is an angle between the first rotation axis 116 and the another beam, so that the laser detector (such as the laser detector 160 in FIG. 1) can receive the first lasers 112, 212, 312 and the second lasers 114, 214, 314 and determine the position difference data based on the positions a and b irradiated on the laser detector 160 by the first lasers 112, 212, 312 and the second lasers 114, 214 314 separately to provide assistance for the subsequent determination of the distance between the laser detector 160 and the laser emitting module 110 included in the rotating laser apparatus.

At this time, as shown in FIG. 1, it is assumed that the distance between the positions 112a and 114a irradiated on the laser detector 160 by the first laser 112, 212, 312 and the second laser 114, 214 314 is h, the angle between the non-overlapped first laser surface and the second laser surface is θ, then it is understood according to the Pythagorean theorem that the distance d between the laser emitting module 110 and the laser detector 160 can be obtained as:

d=h/tan(θ)

In an embodiment according to the present disclosure, the first laser surface and the second laser surface are symmetrical about a plane perpendicular to the first rotation axis. In this way, it can be ensured that although one of the first lasers 112, 212, 312 and the second lasers 114, 214, 314 is not perpendicular to the first rotation axis 116, the first laser surface and the second laser surface formed by the lasers 112, 212, 312 and the second lasers 114, 214, 314 respectively are symmetrical about a plane perpendicular to the first rotation axis 116, so that the laser detector 160 can receive the first lasers 112, 212, 312 and the second lasers 114, 214, 314 and determine the position difference data based on the positions 112a and 114a irradiated on the laser detector 160 by the first lasers 112, 212, 312 and the second laser 114, 214 314 separately to provide assistance for the subsequent determination of the distance between the laser detector and the laser emitting module included in the rotating laser apparatus. In such an embodiment, it is assumed that the distance between the positions 112a and 114a irradiated on the laser detector 160 by the first lasers 112, 212, 312 and the second laser 114, 214 314 is h, and the angle between the non-overlapped first laser surface and the second laser surface is θ, then it is understood according to the Pythagorean theorem that the distance d between the laser emitting module 110 and the laser detector 160 can be obtained as:

d=(h/2)/tan(θ/2)

In an embodiment according to the present disclosure, the first rotation axis is a vertical rotation axis or a horizontal rotation axis. In this way, the rotating laser apparatus can not only scan the laser horizontally to measure the distance between the laser detector and the rotating laser apparatus, but also scan the laser vertically to measure the distance between the laser detector and the rotating laser apparatus.

In an embodiment according to the present disclosure, the rotating laser apparatus further includes:

A laser detector having a first distance away from the laser emitting module and configured to receive the first laser and the second laser and determine a position difference data based on positions irradiated on the laser detector by the first laser and the second laser. In this way, the first laser and the second laser at the first included angle can be received, and the position difference data can be determined based on the positions irradiated on the laser detector by the first laser and the second laser, thereby providing assistance for the subsequent determination of the distance between the laser detector and the rotating laser apparatus.

In an embodiment according to the present disclosure, the rotating laser apparatus further includes:

A processing module configured to determine a first distance between the laser emitting module and the laser detector based on the position difference data and the first included angle.

In this way, the rotating laser apparatus further includes a processing module capable of processing the acquired data to obtain the first distance between the laser emitting module and the laser detector, which can implement the purpose of the present disclosure in an advantageous manner.

In an embodiment according to the present disclosure, the processing module is configured to be fixedly connected to the base or the laser detector. In this way, it is indicated that the processing module can be installed or disposed at the base, that is, at the body of the rotating laser apparatus, or at the laser detector.

In addition, the second aspect of the present disclosure also provides a laser ranging method, FIG. 4 shows a flow chart of the laser ranging method 400 for distance measurement by means of the aforementioned rotating laser apparatus, it can be seen from the figure that the laser ranging method 400 includes the following steps:

First, in the method step 410, generating first laser and second laser using a laser emitting module, wherein a the first laser and the second laser form a first included angle;

Second, in the method step 420, rotating the first laser and the second laser around a first rotation axis respectively using a rotating module to form a first laser surface and a second laser surface that do not overlap with each other;

Next, in the method step 430, receiving, by a laser detector that is a first distance away from the laser emitting module, the first laser and the second laser and determining position difference data based on positions irradiated on the laser detector by the first laser and the second laser; and

Finally, in the method step 440, determining the first distance between the laser emitting module and the laser detector based on the position difference data and the first included angle using a processing module.

Therefore, the rotating laser apparatus has the ability to emit first laser and second laser at a first included angle, thereby an additional tilting mechanism such as a leveling device is not required, so as to simplify the structure of the rotating laser apparatus; meanwhile, due to the first included angle between the first laser and the second laser is pre-configured, there is no angular error to make the measured distance more accurate; furthermore, there is no need to operate the tilt angle of the laser when a distance measurement is performed every time, thereby simplifying the distance measuring operation, and improving the user experience of using the rotating laser apparatus for distance measurement.

In some embodiments, the detection surface of the laser detector for receiving the first laser and the second laser is perpendicular to the first laser or the second laser. Therefore, it can be realized that the line segments which are respectively from the starting point of the laser emission of the first laser to the irradiation point on the laser detector, from the starting point of the laser emission of the second laser to the irradiation point on the laser detector, and starting point of the laser emission of the first laser to the starting point of the laser emission of the second laser form a right triangle, thereby calculating the length of the side formed by one of the first laser and the second laser which is perpendicular to the detection surface of the laser detector according to the Pythagorean theorem, i.e., the first distance between the laser emitting module and the laser detector.

In an embodiment according to the present disclosure, generating the first laser and the second laser using the laser emitting module further includes:

generating the first laser using a first laser emitter included in the laser emitting module; and

generating the second laser using a second laser emitter included in the laser emitting module.

In this way, two independent laser emitters can be adopted to generate the first laser and the second laser, so that the emission angles and wavelength ranges of the first laser and the second laser can be controlled separately to configure the first laser and the second laser for different application scenarios.

In an embodiment according to the present disclosure, the first laser and the second laser have different wavelengths. In this way, an object such as the laser detector receiving the first laser and the second laser can distinguish the first laser from the second laser by wavelength, so as to provide assistance for subsequent laser ranging.

In an embodiment according to the present disclosure, the first laser is visible light and the second laser is invisible light. In this way, an object such as the laser detector receiving the first laser and the second laser can distinguish the first laser from the second laser by determining whether the laser is visible, so as to provide assistance for subsequent laser ranging.

In an embodiment according to the present disclosure, generating the first laser and the second laser using the laser emitting module further includes:

generating a laser using the laser emitter included in the laser emitting module; and

adjusting, by an optical device included in the laser emitting module, the generated laser to produce the first laser and the second laser.

In this way, it is possible to generate two laser beams for laser ranging by only one laser emitter, so that the structure of the rotating laser apparatus can be further simplified and the manufacturing cost thereof can be reduced.

In an embodiment according to the present disclosure, one of the first laser surface and the second laser surface is perpendicular to the first rotation axis. In this way, it can be ensured that one of the first laser and the second laser is perpendicular to the first rotation axis, and the other of the first laser and the second laser is not perpendicular to the first rotation axis, that is, presents an angle with the first rotation axis, so that the laser detector can receive the first laser and the second laser and determine the position difference data based on positions irradiated on the laser detector by the first laser and the second laser to provide assistance for the subsequent determination of the distance between the laser detector and the rotating laser apparatus.

In an embodiment according to the present disclosure, the first laser surface and the second laser surface are symmetrical about a plane perpendicular to the first rotation axis. In this way, it can be ensured that although one of the first laser and the second laser is not perpendicular to the first rotation axis, the first laser surface and the second laser surface formed by the first laser and the second laser respectively are symmetrical about a plane perpendicular to the first rotation axis, so that the laser detector can receive the first laser and the second laser and determine the position difference data based on the positions irradiated on the laser detector by the first laser and the second laser, to provide assistance for the subsequent determination of the distance between the laser detector and the rotating laser apparatus.

In an embodiment according to the present disclosure, the projections of the first laser and the second laser on a plane perpendicular to the first rotation axis are on the same straight line. In this way, the first laser and the plane which makes the first laser perpendicular to the first rotation axis are either in the same direction or differ by 180 degrees, so as to determine the distance between the laser detector and the rotating laser apparatus more accurately.

In an embodiment according to the present disclosure, the first rotation axis is a vertical rotation axis or a horizontal rotation axis. In this way, the rotating laser apparatus can not only scan the laser horizontally to measure the distance between the laser detector and the rotating laser apparatus, but also scan the laser vertically to measure the distance between the laser detector and the rotating laser apparatus.

Based on the laser ranging method disclosed in the present disclosure, several points on the same plane can be measured to form a contour line or a trajectory line, and then the area calculation is further performed, for example, by the method of dividing a square.

Those skilled in the art should understand that the modifications and variations of the various embodiments disclosed above can be made without departing from the essence of the invention. Therefore, the protection scope of the present disclosure should be defined by the appended claims.

Although different exemplary embodiments of the present disclosure have been described, it is obvious to those skilled in the art that various changes and modifications can be made, which can achieve some of the advantages of the present disclosure without departing from the spirit and scope of the present disclosure. For those who are quite skilled in the art, other components performing the same function can be replaced as appropriate. It should be mentioned that the features explained here with reference to particular figures can be combined with features of other figures, even in those cases where this is not explicitly mentioned. In addition, the method of the present disclosure can be implemented either in all software implementations using appropriate processor instructions or in a hybrid implementation using a combination of hardware logic and software logic to achieve the same result. Such modifications to the solution according to the invention are intended to be covered by the appended claims.

What is claimed is:

1. A rotating laser apparatus, comprising:
a laser emitting module configured to emit a first laser and a second laser, wherein the first laser and the second laser form a first included angle;
a rotating module configured to make the first laser and the second laser respectively rotate around a first rotation axis to form a first laser surface and a second laser surface that do not overlap with each other; and
a base connected to the laser emitting module and the rotating module and configured to support the laser emitting module and the rotating module.

2. The rotating laser apparatus of claim 1, wherein the laser emitting module comprises a first laser emitter configured to generate the first laser and a second laser emitter configured to generate the second laser.

3. The rotating laser apparatus of claim 2, wherein the first laser and the second laser have different wavelengths.

4. The rotating laser apparatus of claim 1, wherein the first laser is visible light and the second laser is invisible light.

5. The rotating laser apparatus of claim 1, wherein the laser emitting module comprises a laser emitter and an optical device configured to adjust a direction of a laser generated by the laser emitter, wherein the optical device is configured to adjust the laser generated by the laser emitter to produce the first laser and the second laser.

6. The rotating laser apparatus of claim 1, wherein projections of the first laser and the second laser on a plane perpendicular to the first rotation axis form a second angle.

7. The rotating laser apparatus of claim 1, wherein projections of the first laser and the second laser on a plane perpendicular to the first rotation axis are on a same straight line.

8. The rotating laser apparatus of claim 1, wherein only one of the first laser surface and the second laser surface is perpendicular to the first rotation axis.

9. The rotating laser apparatus of claim 1, wherein the first laser surface and the second laser surface are symmetrical about a plane perpendicular to the first rotation axis.

10. The rotating laser apparatus of claim 1, wherein the first rotation axis is a rotation axis on a vertical direction or a horizontal direction.

11. The rotating laser apparatus of claim 1, further comprising:
a laser detector being a first distance away from the laser emitting module and configured to:
receive the first laser and the second laser; and
determine position difference data based on positions irradiated on the laser detector by the first laser and the second laser.

12. The rotating laser apparatus of claim 11, further comprising:
a processing module configured to determine the first distance between the laser emitting module and the laser detector based on the position difference data and the first included angle.

13. The rotating laser apparatus of claim 12, wherein the processing module is fixedly connected to the base or the laser detector.

14. A laser ranging method, comprising:
generating, by a laser emitting module, a first laser and a second laser, wherein the first laser and the second laser form a first included angle;
rotating the first laser and the second laser around a first rotation axis respectively to form a first laser surface and a second laser surface that do not overlap with each other;
receiving, by a laser detector that is a first distance away from the laser emitting module, the first laser and the second laser and determining position difference data based on positions irradiated on the laser detector by the first laser and the second laser; and
determining a first distance between the laser emitting module and the laser detector based on the position difference data and the first included angle.

15. The laser ranging method of claim 14, wherein generating the first laser and the second laser further comprises:
generating, by a first laser emitter included in the laser emitting module, the first laser; and
generating, by a second laser emitter included in the laser emitting module, the second laser.

16. The laser ranging method of claim 15, wherein the first laser and the second laser have different wavelengths.

17. The laser ranging method of claim 14, wherein the first laser is visible light and the second laser is invisible light.

18. The laser ranging method of claim 14, wherein generating the first laser and the second laser further comprises:
generating, by a laser emitter included in the laser emitting module, a laser; and
adjusting, by an optical device included in the laser emitting module, the generated laser to produce the first laser and the second laser.

19. The laser ranging method of claim 14, wherein only one of the first laser surface and the second laser surface is perpendicular to the first rotation axis.

20. The laser ranging method of claim 14, wherein the first laser surface and the second laser surface are symmetrical about a plane perpendicular to the first rotation axis.

21. The laser ranging method of claim 14, wherein the projections of the first laser and the second laser on a plane perpendicular to the first rotation axis are on a same straight line.

22. The laser ranging method of claim 14, wherein the first rotation axis is a vertical rotation axis or a horizontal rotation axis.
